(19) United States
(12) Patent Application Publication
(10) Pub. No.: US 2015/0310965 A1
(43) Pub. Date: Oct. 29, 2015

(54) DIFFERENTIAL SIGNAL TRANSMISSION CABLE AND PRODUCTION METHOD THEREFOR

(71) Applicant: Hitachi Metals, Ltd., Tokyo (JP)

(72) Inventors: Detian HUANG, Hitachi (JP); Masanori KOBAYASHI, Hitachi (JP); Risa AKIYAMA, Hitachinaka (JP)

(73) Assignee: HITACHI METALS, LTD., Tokyo (JP)

(21) Appl. No.: 14/585,846

(22) Filed: Dec. 30, 2014

(30) Foreign Application Priority Data
Apr. 25, 2014 (JP) 2014-091144

(51) Int. Cl. H01B 11/18; H01B 13/016

(52) U.S. Cl. CPC H01B 11/1891; H01B 11/1852; H01B 13/016

(57) ABSTRACT

A differential signal transmission cable is composed of twin electrically insulated wires arranged side by side in contact with each other, and a drain wire arranged longitudinally along the twin electrically insulated wires. The twin electrically insulated wires include a fusion bonding layer and are integrated in such a manner that the twin electrically insulated wires, excluding their contacted portions, are being coated with that fusion bonding layer.

The present application is based on Japanese patent application No. 2014-091144 filed on Apr. 25, 2014, the entire contents of which are incorporated herein by reference.

### BACKGROUND OF THE INVENTION

1. Field of the Invention

This invention relates to a differential signal transmission cable, which is designed for as high frequency signal transmission at a few GHz or higher in a differential manner, and a production method for that differential signal transmission cable.

2. Description of the Related Art

For high frequency signal transmission at a few GHz or higher, differential signal transmission has been adopted. In the differential signal transmission, two phase-inverted (180 degrees out of phase) signals are transmitted in twin electrically insulated wires respectively, and at a receiving end of the twin electrically insulated wires, a difference between the two signals is synthesized and output. In the differential signal transmission, directions of flow of currents through the twin electrically insulated wires are opposite each other. The differential signal transmission therefore allows for decreasing outward electromagnetic radiation. Also, because noise is superimposed equally on the twin electrically insulated wires, the differential signal transmission allows for cancelling out effects of the noise at the receiving end of the twin electrically insulated wires.

As a transmission path for as high frequency signal transmission at a few GHz or higher, a conventional differential signal transmission cable 300 as shown in FIG. 3 is known that comprises twin electrically insulated wires 301, which are arranged side by side in contact with each other and which include a respective outermost fusion bonding layer 303 formed therearound, and a drain wire 302, which is arranged in contact with both of the twin electrically insulated wires 301. In the differential signal transmission cable 300 as shown in FIG. 3, the twin electrically insulated wires 301 and the drain wire 302 are joined together with the respective fusion bonding layers 303 therebetween of the twin electrically insulated wires 301 respectively.

In the differential signal transmission cable 300, because the twin electrically insulated wires 301 and the drain wire 302 are joined together with the outermost fusion bonding layers 303 therebetween formed around the electrically insulated wires 301 respectively, no transmission path length difference between the twin electrically insulated wires 301 is likely to occur, even if the differential signal transmission cable 300 is bent. The differential signal transmission cable 300 therefore allows an intra-pair delay time difference that occurs between the twin electrically insulated wires 301 to be small.

Refer to e.g. JP-A-2003-346566.

### SUMMARY OF THE INVENTION

Now, in the conventional differential signal transmission cable 300, in order to join the twin electrically insulated wires 301 and the drain wire 302 together with the fusion bonding layers 303 respectively therebetween, it is necessary to fuse the fusion bonding layers 303 with the twin electrically insulated wires 301 and the drain wire 302 being in contact with each other with the fusion bonding layers 303 respectively therebetween, but at this point, the fusion bonding layers 303 may not be fused uniformly in cable longitudinal direction.

When the fusion bonding layers 303 are not fused uniformly in the cable longitudinal direction, the fusion bonding layers 303 interposed between the twin electrically insulated wires 301 are uneven in quantity in the cable longitudinal direction, and therefore a distance between the twin electrically insulated wires 301 varies in the cable longitudinal direction.

The variation in the cable longitudinal direction in the distance between the twin electrically insulated wires 301 increases the intra-pair delay time difference caused between the twin electrically insulated wires 301, thus significantly worsening an attenuation property in as high frequency signal transmission at a few GHz or higher in the differential signal transmission cable 300.

Accordingly, it is an object of the present invention to provide a differential signal transmission cable, which, when bent, is likely to have no transmission path length difference between twin electrically insulated wires thereof, and which allows an intra-pair delay time difference caused between the twin electrically insulated wires to be maintained small, a distance between the twin electrically insulated wires to be constant in cable longitudinal direction, and an attenuation property in as high frequency signal transmission at a few GHz or higher to be enhanced in comparison with the conventional art. It is also another object of the present invention to provide a production method for that differential signal transmission cable.

(1) According to one embodiment of the invention, a differential signal transmission cable comprises:

twin electrically insulated wires arranged side by side in contact with each other, the twin electrically insulated wires including a fusion bonding layer and being integrated in such a manner that the twin electrically insulated wires, excluding their contacted portions, are being coated with that fusion bonding layer; and

a drain wire arranged longitudinally along the twin electrically insulated wires.

In one embodiment, the following modifications and changes may be made.

(i) The differential signal transmission cable further comprises a binder tape wrapped around a circumference of the twin electrically insulated wires together.

(ii) The binder tape includes an innermost thermoplastic fusion bonding layer, and the fusion bonding layer is being formed by heating the twin electrically insulated wires wrapped with the binder tape in such a manner that the thermoplastic fusion bonding layer is fused and turned to a periphery of the twin electrically insulated wires.

(iii) The binder tape includes an outermost shielding layer including an outer surface, and the drain wire is arranged in contact with the outer surface of the shielding layer.

(iv) The electrically insulated wires include a respective signal wire conductor, and a respective insulating layer formed around a circumference of the respective signal wire conductor, the insulating layers being formed of a foamed layer.

(v) The differential signal transmission cable further comprises a jacket tape wrapped around an outermost circumference of the twin electrically insulated wires together.

(2) According to another embodiment of the invention, a differential signal transmission cable production method comprises:

arranging twin electrically insulated wires side by side in contact with each other;

wrapping a binder tape including an innermost thermoplastic fusion bonding layer around a circumference of the twin electrically insulated wires together; and

heating the twin electrically insulated wires wrapped with the binder tape to fuse and turn the thermoplastic fusion bonding layer to a periphery of the twin electrically insulated wires and thereby coat the twin electrically insulated wires, excluding their contacted portions, with the fusion bonding layer to integrate the twin electrically insulated wires.

(Points of the Invention)

The present invention allows for providing the differential signal transmission cable, which, when bent, is likely to have no transmission path length difference between twin electrically insulated wires thereof, and which allows an intra-pair delay time difference caused between the twin electrically insulated wires to be maintained small, a distance between the twin electrically insulated wires to be constant in cable longitudinal direction, and an attenuation property in as high frequency signal transmission at a few GHz or higher to be enhanced in comparison with the conventional art. It is also possible to provide the method for producing that differential signal transmission cable.

### BRIEF DESCRIPTION OF THE DRAWINGS

The preferred embodiments according to the invention will be explained below referring to the drawings, wherein:

FIG. 1 is a cross sectional schematic view showing a differential signal transmission cable according to the present invention;

FIG. 2 is a cross sectional schematic view showing the differential signal transmission cable according to the present invention, before a fusion bonding layer is formed; and

FIG. 3 is a cross sectional schematic view showing a differential signal transmission cable in conventional art.

### DETAILED DESCRIPTION OF THE PREFERRED EMBODIMENTS

Below is described a preferred embodiment according to the invention, in conjunction with the accompanying drawings.

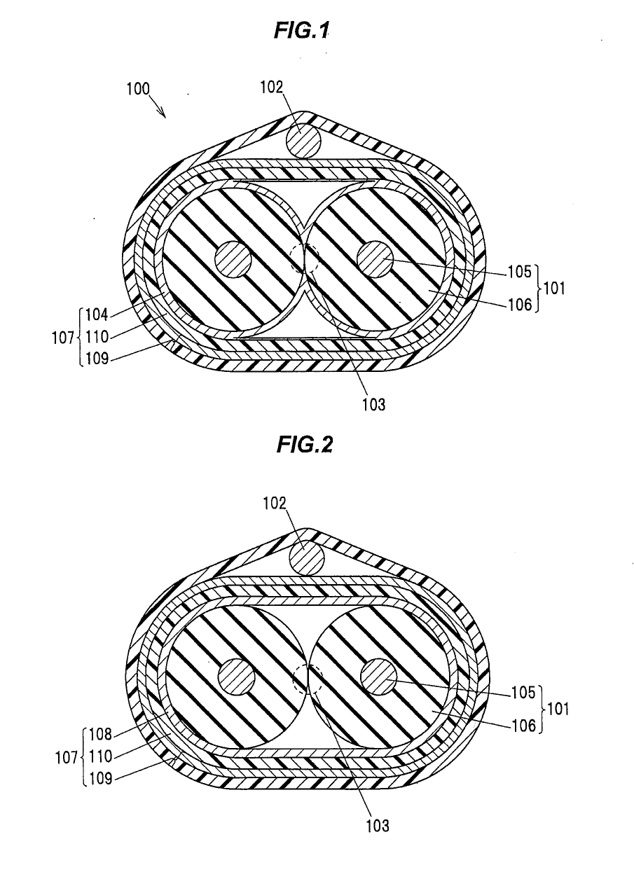

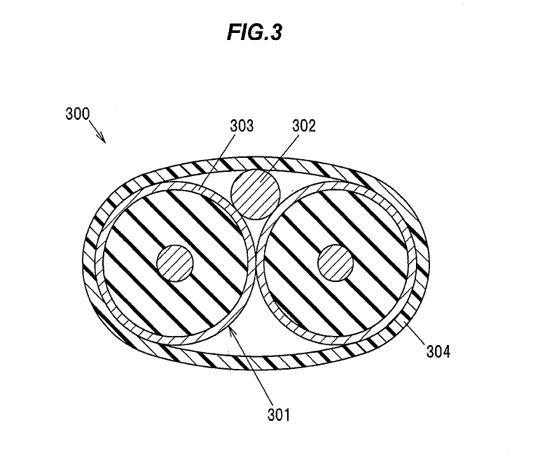

As shown in FIG. 1, a differential signal transmission cable 100 in the preferred embodiment of the present invention is composed of twin electrically insulated wires 101, which are arranged side by side in contact with each other, and a drain wire 102, which is arranged longitudinally along the twin electrically insulated wires 101.

The twin electrically insulated wires 101 include a fusion bonding layer 104 and are integrated in such a manner that the twin electrically insulated wires 101, excluding their contacted portions 103, are being coated with that fusion bonding layer 104.

These electrically insulated wires 101 comprise a respective signal wire conductor 105, and a respective insulating layer 106 formed around a circumference of the respective signal wire conductor 105. In the electrically insulated wires 101, the signal wire conductors 105 are arranged in the cable longitudinal direction and substantially at the respective centers in cross sectional view of the insulating layers 106 respectively, in other words, the signal wire conductors 105 are substantially not eccentric to the respective outer diameters of the electrically insulated wires 101 respectively, and also the outer diameters of the insulating layers 106 are substantially constant in the cable longitudinal direction.

This allows the distance between the twin electrically insulated wires 101 of the differential signal transmission cable 100, i.e. the distance between the two signal wire conductors 105 thereof to be substantially constant in the cable longitudinal direction, and the intra-pair delay time difference caused between the twin electrically insulated wires 101 to be small, in comparison with the conventional art. Therefore, no attenuation property in as high frequency signal transmission at a few GHz or higher is likely to be worse, in comparison with the conventional art.

The signal wire conductors 105 are composed of a stranded wire, which is formed by stranding a multiplicity of signal wire strands together. This allows for enhancing the flexibility and bending resistance of the signal wire conductors 105, in comparison with when the signal wire conductors 105 are made of a single signal wire strand, i.e. a solid wire.

The insulating layers 106 may be formed of a solid layer that is formed simply by extrusion coating of a fluorine resin or the like around a respective circumference of the signal wire conductors 105, but it is preferable that the insulating layers 106 are formed of a foamed layer that is formed by extrusion coating of a physically or chemically foamed fluorine resin or the like around the respective circumference of the signal wire conductors 105. This allows the insulating layers 106 to have a small dielectric constant in comparison with when the insulating layers 106 are formed of the solid layer, thereby allowing for producing the electrically insulated wires 101 suitable for as high frequency signal transmission at a few GHz or higher.

It is preferable that the drain wire 102 is formed by stranding a plurality of ground wire strands together. This allows for enhancing the flexibility and bending resistance of the drain wire 102, in comparison with when the drain wire 102 is made of a single ground wire strand, i.e. a solid wire.

Also, it is preferable that the differential signal transmission cable 100 in the preferred embodiment of the present invention, besides these, further includes a binder tape 107, which is wrapped around a circumference of the twin electrically insulated wires 101 together. This allows the twin electrically insulated wires 101 and the drain wire 102 to be prevented from contact with each other, the twin electrically insulated wires 101 to be prevented from flattening and deformation due to a force for the drain wire 302 to be bound as in the conventional differential signal transmission cable 300, and the distance between the twin electrically insulated wires 101 and the distance between the twin electrically insulated wires 101 and the drain wire 102 to be prevented from varying in the cable longitudinal direction.

As a result, the differential signal transmission cable 100 allows for the insulating layers 106 to be unlikely to be deformed by the drain wire 102 binding force even though the insulating layers 106 are made of the foamed layer being low in hardness in comparison with the solid layer, and the differential signal transmission cable 100 allows for suppressing an increase in the intra-pair delay time difference caused between the twin electrically insulated wires 101.

FIG. 2 is a cross sectional schematic view showing the differential signal transmission cable 100 before the fusion bonding layer 104 in FIG. 1 is formed. As shown in FIG. 2, the binder tape 107 immediately after being wrapped around the circumference of the twin electrically insulated wires 101 together includes an innermost thermoplastic fusion bonding layer 108, and the fusion bonding layer 104 is formed by heating the twin electrically insulated wires 101 wrapped with the binder tape 107 in such a manner that the thermoplastic fusion bonding layer 108 is fused and turned to a periphery of the twin electrically insulated wires 101. That is, the fusion bonding layer 104 is formed by heating the twin electrically insulated wires 101 wrapped with the binder tape 107 in such a manner that the thermoplastic fusion bonding layer 108 is fused and turned to a periphery of the twin electrically insulated wires 101 by capillary action.

At this point, because the twin electrically insulated wires 101 are in contact with each other in their contacted portions 103 with no gap forming therebetween, the thermoplastic fusion bonding layer 108 is not turned to between the contacted portions 103, thus the fusion bonding layer 104 being not interposed between the contacted portions 103 of the twin electrically insulated wires 101.

The thermoplastic fusion bonding layer 108 is preferably made of acrylic adhesive. According to such a configuration, it is possible to form the fusion bonding layer 104 by melting only the thermoplastic fusion bonding layer 108 without melting the insulating layers 106 when heated.

As a result, the differential signal transmission cable 100 allows for its twin electrically insulated wires 101 to be integrated with the fusion bonding layer 104, and the distance between its twin electrically insulated wires 101 to be substantially constant in the cable longitudinal direction.

The binder tape 107 includes an outermost shielding layer 109 including an outer surface, and it is preferable that the drain wire 102 is arranged in contact with the outer surface of the shielding layer 109. This allows for ensuring grounding on an entire circumference of the differential signal transmission cable 100, therefore the distance between the two signal wire conductors 105 and ground being unlikely to vary, and the intra-pair delay time difference caused between the twin electrically insulated wires 101 being unlikely to increase, in comparison with when grounding is ensured with only the drain wire 102.

Note that in the conventional differential signal transmission cable 300, due to the twin electrically insulated wires 301 and the drain wire 302 being joined together with the respective fusion bonding layers 303 therebetween of the twin electrically insulated wires 301 respectively, it is difficult to branch only the drain wire 302 from the twin electrically insulated wires 301 at the time of cable termination process.

In contrast, in the differential signal transmission cable 100, since the binder tape 107 is interposed between the twin electrically insulated wires 101 and the drain wire 102, the twin electrically insulated wires 101 and the drain wire 102 are not joined together with the fusion bonding layer 104 therebetween. It is therefore possible to easily branch the drain wire 102 from the twin electrically insulated wires 101 at the time of cable termination process.

Also, in the conventional differential signal transmission cable 300, due to the whole of the contacted portions of the twin electrically insulated wires 301 being tightly fixed by the fusion bonding layers 303, it is difficult to branch the twin electrically insulated wires 301 at the time of cable termination process.

In contrast, in the differential signal transmission cable 100, the fusion bonding layer 104 is not interposed between the contacted portions 103 of the twin electrically insulated wires 101, and the twin electrically insulated wires 101 are joined together by upper and lower fusion bonding layer 104 portions, as illustrated in FIG. 1, formed by the thermoplastic fusion bonding layer 108 being turned to the periphery of the twin electrically insulated wires 101. It is therefore possible to easily branch the twin electrically insulated wires 101 at the time of cable termination process.

This allows for greatly enhancing the termination processability of the differential signal transmission cable 100, in comparison with that of the conventional differential signal transmission cable 300.

It is preferred that the thermoplastic fusion bonding layer 108 and the shielding layer 109 are provided separately as a front layer and a back layer, respectively, of a reinforcing layer 110 made of polyethylene terephthalate (PET) or the like. This, even after the thermoplastic fusion bonding layer 108 is fused to form the fusion bonding layer 104, allows the reinforcing layer 110 to remain in contact with the entire circumference of the inner surface of the shielding layer 109. Therefore, the shielding layer 109 can, without breaking due to stress at the time of bending, etc., maintain the shielding property of the differential signal transmission cable 100.

As described so far, the differential signal transmission cable 100, when bent, is likely to have no transmission path length difference between its twin electrically insulated wires 101, and allows its intra-pair delay time difference caused between the twin electrically insulated wires 101 to be maintained small, the distance between the twin electrically insulated wires 101 to be constant in the cable longitudinal direction, and its attenuation property in as high frequency signal transmission as a few GHz or higher to be enhanced in comparison with the conventional art.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A differential signal transmission cable, comprising:
twin electrically insulated wires arranged side by side in contact with each other, the twin electrically insulated wires including a fusion bonding layer and being integrated in such a manner that the twin electrically insulated wires, excluding their contacted portions, are being coated with that fusion bonding layer; and
a drain wire arranged longitudinally along the twin electrically insulated wires.

2. The differential signal transmission cable according to claim 1, further comprising a binder tape wrapped around a circumference of the twin electrically insulated wires together.

3. The differential signal transmission cable according to claim 2, wherein the binder tape includes an innermost thermoplastic fusion bonding layer, and the fusion bonding layer is being formed by heating the twin electrically insulated wires wrapped with the binder tape in such a manner that the thermoplastic fusion bonding layer is fused and turned to a periphery of the twin electrically insulated wires.

4. The differential signal transmission cable according to claim 2, wherein the binder tape includes an outermost shielding layer including an outer surface, and the drain wire is arranged in contact with the outer surface of the shielding layer.

5. The differential signal transmission cable according to claim 4, wherein the electrically insulated wires include a respective signal wire conductor, and a respective insulating layer formed around a circumference of the respective signal wire conductor, the insulating layers being formed of a foamed layer.

6. The differential signal transmission cable according to claim 1, further comprising a jacket tape wrapped around an outermost circumference of the twin electrically insulated wires together.

7. A differential signal transmission cable production method, comprising:
arranging twin electrically insulated wires side by side in contact with each other;
wrapping a binder tape including an innermost thermoplastic fusion bonding layer around a circumference of the twin electrically insulated wires together; and
heating the twin electrically insulated wires wrapped with the binder tape to fuse and turn the thermoplastic fusion bonding layer to a periphery of the twin electrically insulated wires and thereby coat the twin electrically insulated wires, excluding their contacted portions, with the fusion bonding layer to integrate the twin electrically insulated wires.
